(19) United States
(12) Patent Application Publication
(10) Pub. No.: US 2008/0127954 A1
(43) Pub. Date: Jun. 5, 2008

(54) In line mixing chamber for internal combustion engine

(76) Inventor: George J. Coates, Wall, NJ (US)

Correspondence Address: CLIFFORD G. FRAYNE, 136 DRUM POINT RD, SUITE 7A, BRICK, NJ, 08723, US

(21) Appl. No.: 11/605,715

(22) Filed: Nov. 30, 2006

(51) Int. Cl. F02M 29/00

(52) U.S. Cl. 123/590

(57) ABSTRACT

A mixing chamber for dissimilar or alternate fuels for use in an internal combustion engine, the mixing chamber comprising a centrifugal mixing chamber having a plurality of pressurized alternative fuel intake conduits tangentially arranged with said mixing chamber to feed a plurality of alternative fuels centrifugally into said mixing chamber for mixing, the mixing chamber having a outlet conduit for directing a mixture of the alternative fuels to an injector for atomization of the mixture of alternative fuels into the cylinders of the internal combustion engine, the mixing chamber having a feedback mechanism for controlling the quantity of alternative fuels introduced into the mixing chamber.

### BACKGROUND OF THE INVENTION

1. Field of the Invention

The present invention relates to internal combustion engines, and in particular, to a mixing chamber positioned between the fuel reservoirs and the internal combustion chamber, the mixing chamber for the mixing of alternative fuels such as diesel, bio-diesel, and ethynol, gasoline and ethynol and the like prior to introduction into the internal combustion chamber.

2. Description of the Prior Art

Initially there were two types of internal combustion engines, those that ran on gasoline, and those that ran on diesel fuel. With the advent of increased fuel prices, fuel scarcities, and environmental concerns, the primary fuels for motor vehicles have been changing, either voluntarily or by government decree. In most locales in the United States, ethynol is a mandatory additive to gasoline during the summer months for environmental concerns. Ethynol is increasing being considered as an alternative to gasoline because of high oil prices. Bio-diesel has become popular with certain environmentalists and is now used in a mixture with regular diesel. Still further, other alternative fuels are being developed for both the gasoline powered engine and the diesel powered engine.

It is anticipated that eventually both gasoline and diesel engines will run on a variety of fuels and alternate fuels and that the best performance that would be achieved from these engines would be their being fueled by a mixture of alternative fuels in percentages which would give the optimum performance for the engine based on the fuels being used. Therefore, there is a need for an inline mixing chamber having few or no moving parts which would allow the mixing of alternative fuels prior to their introduction or injection into the combustion chamber of either the gasoline or diesel engine.

The Applicant herein has addressed considerable time and energy to the novel improvement of internal combustion engines, and in particular, to the development of rotary valves for such engines which improve the efficiency of the engines, improve the emissions of the engine, and allow the engine to operate on a variety of different fuels not suitable for poppet valve engines because of the heat generated. The patents developed as a result of Applicant's endeavors include the following, which are hereby incorporated by reference. U.S. Pat. No. 4,944,261; U.S. Pat. No. 4,953,527; U.S. Pat. No. 4,976,232; U.S. Pat. No. 4,989,558; U.S. Pat. No. 4,989,576; U.S. Pat. No. 5,109,814; U.S. Pat. Nos. 5,361,739; 5,601,405; U.S. Pat. No. 6,308,676; U.S. Pat. Nos. 6,666,458; 6,718,933; U.S. Pat. No. 6,779,504; U.S. Pat. No. 6,789,516; and U.S. Pat. No. 6,880,511.

### OBJECTS OF THE INVENTION

An object of the present invention is to provide for a novel mixing chamber having few or no moving parts which is capable of mixing a plurality of fuels and alternate fuels in a homogenious mixture prior to their introduction or injection into the combustion chamber of either a gasoline internal combustion engine, or a diesel engine combined with natural gas and/or propane.

Another object of the present invention is to provide a novel mixing chamber which is light weight, yet which can withstand the pressures of the homogenious mixing of the disparate alternative fuels prior to their introduction into the combustion chamber.

A still further object of the present invention is to provide for a novel mixing chamber in which the velocity of the alternative fuels introduced into the mixing chamber accomplish the homogenious mixing without the need for moving parts.

A still further object of the present invention is to provide for a novel mixing chamber in which sensors would automatically control the quantity of each alternative fuel introduced into the mixing chamber based upon engine performance and exhaust emission sensors.

### SUMMARY OF THE INVENTION

A mixing chamber for dissimilar or alternate fuels for use in an internal combustion engine, the mixing chamber comprising a centrifugal mixing chamber having a plurality of pressurized alternative fuel intake conduits tangentially arranged with said mixing chamber to feed a plurality of alternative fuels centrifugally into said mixing chamber for mixing, the mixing chamber having a outlet conduit for directing a mixture of the alternative fuels to the cylinders of the internal combustion engine, the mixing chamber having a feedback mechanism for controlling the quantity of alternative fuels introduced into the mixing chamber.

### BRIEF DESCRIPTION OF THE DRAWINGS

These and other objects of the present invention will become apparent, particularly when taken in light of the following illustrations wherein:

FIG. 1 is an exploded view of the mixing chamber of the present invention.

FIG. 2 is a schematic view of the mixing chamber in relationship to the fuel source and the engine.

### DETAILED DESCRIPTION OF THE INVENTION

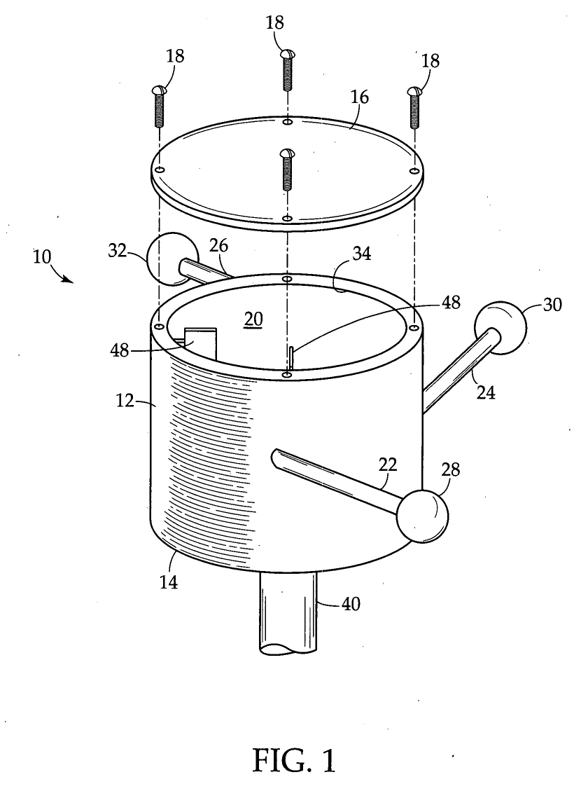

FIG. 1 is an exploded view of the mixing chamber 10 of the present invention. In the embodiment illustrated in FIG. 1, mixing chamber 10 is generally cylindrical in shape having a circumferential side wall 12, an integrated bottom wall 14, and a removable securable top wall 16 secured by a plurality of securing means 18. The top wall 16 must be secured to the mixing chamber 10 in a secure manner since the system is under pressure.

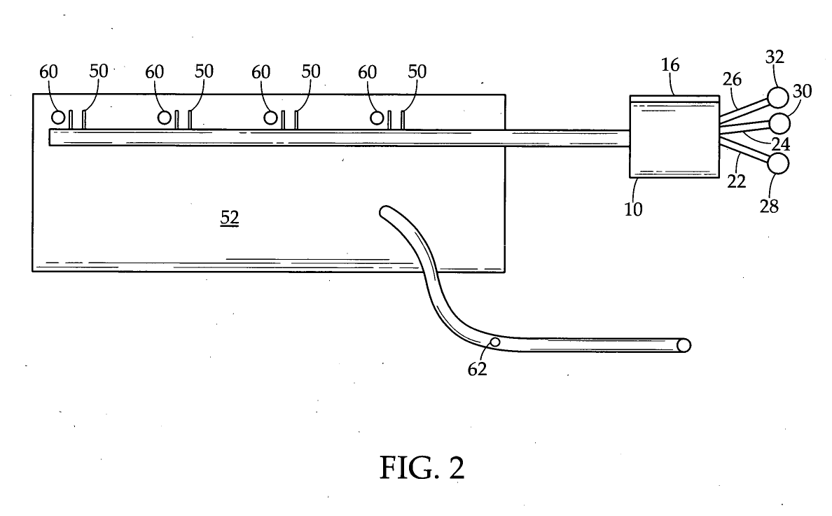

Communicating with the interior 20 of the mixing chamber 10 are a plurality of the fuel conduits 22, 24, and 26. Each of these fuel lines is in communication with a source of fuel or alternative fuel 28, 30, and 32, such as diesel, biodiesel, ethanol or the like. These fuels are stored in fuel chambers as described with respect to FIG. 2 and are selectively introduced under pressure into the mixing chamber 10 in the desired quantities.

The fuel conduits 22, 24, and 26 are tangentially positioned with respect to the inner circumferential wall 34 of the mixing chamber 10. In this configuration, when the fuel or alternative fuel, under pressure is introduced by means of the conduit lines 22, 24 or 26, it swirls within the mixing chamber 10 causing the pressure of the individual fuel or alternative fuel lines to generate a laminar flow and laminar mixing between the disparite fuels within the mixing chamber 10.

In steady state of operation, a mixture of the fuels or alternative fuels introduced into the mixing chamber 10 are drawn off by means of an exit conduit 40 formed in either the bottom wall 14 or the top removable wall 16 of mixing chamber 10. Exit conduit 40 is in communication with an injection system 50 of the internal combustion engine 52 as more fully described in FIG. 2 for the introduction of the fuel/alternative fuel mixture into the chambers of the internal combustion engine for combustion.

In the preferred embodiment, the pressurized introduction of the fuel or alternative fuel into the cylindrical mixing chamber 10 would result in a homogeneous mixing of the fuel/alternative fuel, into a homogeneous mixture for subsequent introduction into the injectors of an internal combustion engine. In an alternative embodiment, a plurality of baffle members 48 may further be positioned within mixing chamber 10 to assist in the homogeneous mixing of the fuel/alternative fuel constituents into a homogeneous mixture for introduction into the injectors of an internal combustion engine.

FIG. 2 is a schematic illustrating the positioning of the mixing chamber 10 between various fuel reservoirs 28, 30, and 32 for the storage of fuel or alternative fuels with the pressurized fuel conduits 22, 24, and 26 communicating from the fuel/alternative fuel reservoirs to the mixing chamber 10, and an exit conduit 40 communicating from the mixing chamber 10 to the injection system 50 positioned on an internal combustion engine 52 for the subsequent introduction of the homogeneous fuel/alternative fuel mixture into the combustion chamber of the internal combustion engine 52. The flow and quantity of the various fuel/alternative fuels to the mixing chamber and to the internal combustion engine are controlled by a series of sensors 60 on the internal combustion engine and a further series of sensors 62 in the exhaust which automatically determine the quality of emissions and automatically adjust the flow of the fuel/alternative fuels

It will be recognized by one of ordinary skill in the art that the design of the mixing chamber 10 can be modified with a number of pressurized inlet conduits depending on the number or quantity of fuel/alternative fuel mixtures which are desired to be mixed within the mixing chamber 10 prior to introduction into the internal combustion engine. The embodiment illustrated in FIG. 1 illustrates three pressurized inlet conduits to accommodate three separate fuel/alternative fuel sources, however, the number of fuel/alternative fuel sources may be fewer or more than that illustrated in FIG. 1 without departing from the spirit and scope of the invention.

While the present invention has been described with respect to the exemplary embodiments thereof, it will be recognized by those of ordinary skill in the art that many modifications or changes can be achieved without departing from the spirit and scope of the invention. Therefore it is manifestly intended that the invention be limited only by the scope of the claims and the equivalence thereof.

1. An inline mixing chamber for an internal combustion engine operating on a mixture of fuel/alternative fuels, said inline mixing chamber comprising:
a housing having a bottom wall, side wall, and removably securable top wall, said housing defining a chamber, said chamber being cylindrical in internal configuration, there being a plurality of inlet conduits in communication with said chamber, said inlet conduits in tangential orientation to said chamber for the introduction of fuel/alternative fuels into said chamber, under pressure, said fuel/alternative fuels introduced into said chamber forming a homogeneous mixture as a result of centrifugal movement within said chamber under pressure, said chamber having an exit conduit for the removal and transport of said homogeneous mixture of said fuel/alternative fuels to an injection member for injection and atomization of said homogeneous fuel/alternative fuel mixture into the combustion chamber of an internal combustion engine.

2. The inline mixing chamber in accordance with claim 1 wherein said housing is cylindrical in shape defining a cylindrical mixing chamber.

3. The inline mixing chamber in accordance with claim 1 wherein said top wall of said inline mixing chamber is removably securable to said side walls of said inline mixing chamber by means of a plurality of threaded fastening means sufficient to maintain the integrity of the inline mixing chamber when said fuel/alternative fuels are introduced under pressure into said inline mixing chamber.

4. The inline mixing chamber in accordance with claim 1 wherein said cylindrical mixing chamber further includes a plurality of baffles radially inwardly depending from said side wall of said inline mixing chamber to further assist in the homogeneous mixing of said fuel/alternative fuels introduced into said inline mixing chamber.
